(19) United States
(12) Patent Application Publication
(10) Pub. No.: US 2013/0140882 A1
(43) Pub. Date: Jun. 6, 2013

(54) Kinetic Energy Recovery System to recharge the traction storage device of an electric vehicle through inertial differentials between a static mass and the lateral motions of a vehicle in motion.

(71) Applicant: Brooks Alexander Agnew, Concord, NC (US)

(72) Inventor: Brooks Alexander Agnew, Concord, NC (US)

(21) Appl. No.: 13/682,702

(22) Filed: Nov. 20, 2012

Related U.S. Application Data
(60) Provisional application No. 61/565,564, filed on Dec. 1, 2011.

(51) Int. Cl. H02J 7/00

(52) U.S. Cl. CPC H02J 7/00
USPC 307/9.1; 320/139

(57) ABSTRACT

A Kinetic Energy Recovery System to recharge the traction storage device of an electric vehicle through inertial differentials between a static mass and the lateral motions of a vehicle in motion. A modular machine made of an eccentric mass, which tends to remain motionless, against which the vehicle moves, forming the kinetic energy to turn that eccentric wheel, which in turn drives a series of ratios of shafts to generate electricity. Further, this generated electricity is rectified and regulated to the correct voltage to recharge the storage device on board that electric vehicle.

### CROSS REFERENCE TO RELATED APPLICATIONS

The present application claims the priority of U.S. Provisional Application No. 61/565,564, filed on Dec. 1, 2011, which is herein incorporated by reference.

### BACKGROUND OF THE INVENTION

The present invention is in the technical field of energy generation for the purpose of recharging the traction storage device for a high-speed electric vehicle.

### FIELD OF THE INVENTION

### Description of Related Art

Those familiar with the art of power generation recognize that power generation requires physical, chemical, or electronic work to generate electricity. The current invention utilizes the force developed between a static mass and the lateral movements of a highway-speed electric vehicle during normal driving to generate electricity. The lateral movements—stopping, accelerating, turning—are vastly more frequent that stopping events normally utilized for regenerative braking.

Those familiar with the art recognize a linear generator in place of the shock absorbers of an automobile, such as the invention described in U.S. Pat. No. 6,952,060, the contents of which are incorporated by reference, utilizing the repetitive, up and down motions of a highway-speed vehicle during normal driving conditions to generate electricity. This electricity is parasitically collected through a force conversion through vector superposition of the magnetic fields and magnetic flux from a plurality of magnets and supplied to the traction storage device. The current invention is an improvement on this technology as it utilizes the lateral movements of the vehicle movement, rather than the up and down movements of the automobile to generate the electricity. The mass is small enough so as not to affect the comfort or performance of the vehicle, yet large enough that when levered will produce enough kinetic energy to generate significant amounts of electrical energy for the purposes of recharging the traction storage device. Those familiar with the art will recognize the term Kinetic Energy Recovery System (KERS). This is an improvement over the current art, because the normal function of a shock absorber is to rapidly and reliably dampen the oscillations of the springs of an automobile experiencing a bump in the road. The current art in U.S. Pat. No. 6,952,060 (incorporated herein by reference), by way of its function, does not supply this dampening, but rather benefits from the repeated, high-amplitude oscillation of the vehicle. This very high amplitude oscillation, although beneficial for power generation, prevents the tires from maintaining optimum traction with the highway, which is the primary function of an automobile shock absorber, which diminishes the safe handling and braking of the vehicle. The current invention restores the properly designed shock absorber to the automobile and applies the lateral movements, stopping—accelerating, and turning—against a static weight on a lever to turn a shaft to produce a variable frequency electrical signal. This signal is converted into a suitable voltage and is applied to the main traction storage device. Those familiar with the art will recognize that this power generation capacity and energy conversion efficiency may significantly extend the range a highway-speed electric vehicle can travel between plugged in charging sessions.

Those familiar with the art of regenerative braking will recognize that under normal driving conditions of highway-speed automobiles, there are few braking events. Once the energy has been expended to get the electric vehicle to highway speed, the acceleration can stop, and the vehicle can coast without using any electrical power for hundreds of yards at a time. Small amounts of energy, depending upon the mechanical and wind drag and the incline or decline of the road, are all that is occasionally needed to keep the automobile at highway speed. Slowing the vehicle with the traction motor acting as a generator is unpredictable, depending upon the internal resistance of the batteries during the slowing event. The vehicle requires much more energy to accelerate back to the same speed than was recovered through the regeneration process. In short, those familiar with the art will recognize that there is no documented advantage to regenerative braking for the extension of the range of a highway speed electric vehicle.

### BRIEF SUMMARY OF THE INVENTION

The disclosed invention establishes an advantage to the current art, because the force required to turn the crank of the generator does not draw on the energy of the vehicle as it simply remains stationary while the vehicle moves against it during events that would normally be wasted as heat or other forms of energy not beneficial to the vehicle. Simply turning left or right, accelerating or decelerating can generate energy for the batteries.

This summary of the invention does not necessarily describe all features of the invention.

### BRIEF DESCRIPTION OF THE DRAWINGS

FIG. 1 depicts a set of drawings for the stacked plates that contain the moving parts in proper alignment and fit for the Kinetic Energy Recovery System (KERS) construction.

FIG. 2 depicts a drawing of the drive wheel ratios for stepping up the KERS mass into a significant generation event.

FIG. 3 depicts the machine setup of the ratio wheels and the generator to take advantage of the movement of the crank to generate the electricity.

### DETAILED DESCRIPTION OF THE INVENTION

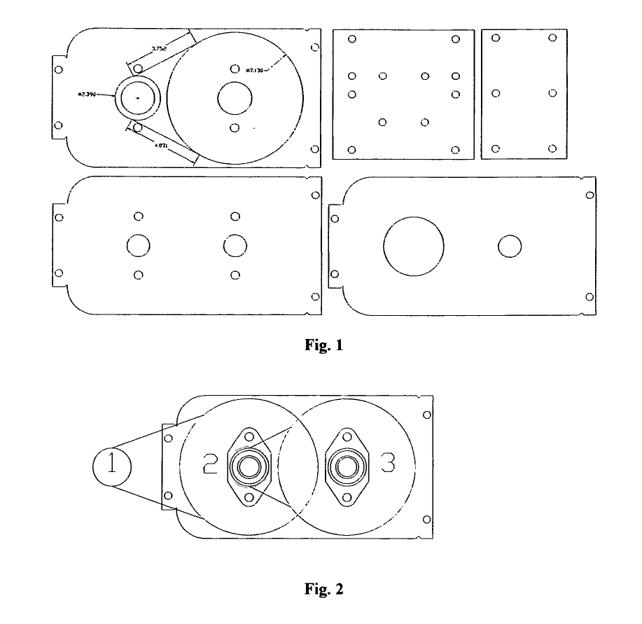

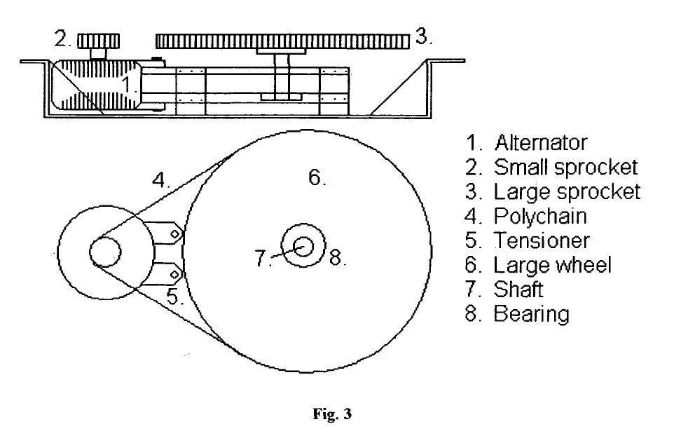

The disclosed invention is modular and formed from layers of mechanisms depicted in FIG. 1 to form a machine depicted in FIG. 2 as a top view and FIG. 3 as a side view thus designed to generate electrical energy from all the lateral movements that an automobile makes during the normal course of highway-speed driving. The basis of the technology is that a mass in FIG. 3 is mounted in an eccentric fashion to a wheel (6) that tends to remain motionless through its inertia compared to the electric vehicle in which the generator is mounted. The force against that inertia, applied by the lateral motions of the electric vehicle, is allowed to form rotational energy by the low-friction mechanism of the invention, which is then converted into electricity by moving a conductor against a magnetic field. The basis of the net energy gain is that the lateral movements are normal to the vehicle, and do not subtract from the set of energy that makes up the automobile in motion. The resulting kinetic energy is converted into electrical power that is shunted to the traction storage device as a series of repetitive short bursts of variable frequency energy rectified into suitable voltage.

The principle of the energy generation is superior to the current state of the art and unique and novel in that it is not the inductive braking or bouncing of the vehicle that is the causative force of power generation. Rather, it is the safe and incidental differential between the inertia of the stationary mass and the movements of the automobile that are lateral or parallel to the ground that are those causative actions.

Now, referring to an embodiment of the invention in more detail, the mass is connected tangentially to the large diameter wheel (#3 in FIG. 2). The center of the large wheel (#3 FIG. 2) contains a small diameter polychain sprocket. That smaller same smaller sprocket is fitted to the center of a second large diameter polychain sprocket (#2 FIG. 2). The outer diameter of sprocket (#2 in FIG. 2) is connected by polychain to the outer diameter of a polychain sprocket that is fitted to the shaft of an alternator or permanent magnet generator or other kinetically driven electrical generator.

Energy is generated through inertial differentials between electric vehicle movements and a static mass. The proposed technology is based upon the principal of work through kinetic energy resulting from the difference between the inertia of a static mass and the lateral movements of an electronic vehicle. More particularly, the static mass has a tendency to remain stationary, while the electronic vehicle turns left, right, speeds up, or slows down. Whereas the current art may collect energy from the “Z” axis, or up and down motion of a vehicle while driving, the proposed technology is a significant improvement. The “Z” direction is held to a minimum and, in fact, dampened as a function of the suspension absorbers to improve the safety and stability of any vehicle, and “X&Y” directions are more likely and ordinary to the operation of the vehicle and less likely to impact the traction of the tires against the pavement. Therefore, the proposed technology is designed to utilize the thousands of lateral movements a vehicle makes to create a potential energy between the static mass and the moving mass of the vehicle. This difference is converted into kinetic energy when the vehicle changes direction, while the static mass tends to remain stationary. That kinetic energy is converted into electrical energy by a generator, which is then directed into the main traction batteries, via direct connection, capacitor interface, or other interceding device.

An embodiment of the present invention is a method of recharging a traction storage device in an electric vehicle. The method may comprise generating energy by positioning an inertial mass on a low-friction rotational apparatus that is generally parallel to a ground plane upon which said electric vehicle is traveling up to and including highway speeds and moved against by the lateral motions of that vehicle as a causative force to generate a series of repetitive pulses of variable frequency electricity, followed by rectifying and transferring said energy into said traction storage device, such as a Lithium chemistry battery, to recharge that device.

Another embodiment of the present invention is an alternator, generator, or other power generation device mechanically driven by the action of an electric vehicle traveling at velocities up to highway speeds against an inertial mass suspended by a low-friction apparatus on said vehicle.

Another embodiment of the present invention is a bi-directional electrical switching circuit integral with an alternator, generator, or other power generation device mechanically driven by the action of an electric vehicle traveling at velocities up to highway speeds against an inertial mass suspended by a low-friction apparatus on said vehicle, which will supply the correct polarity of electricity at suitable voltages to supply a net gain of energy to a traction storage device on an electric vehicle.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Moreover, the terms “consisting”, “comprising” and other derivatives from the term “comprise” are intended to be open-ended terms that specify the presence of any stated features, elements, steps, or components, and are not intended to preclude the presence or addition of one or more other features, elements, integers, steps, components, or groups thereof Moreover, Applicants have endeavored in the present specification and drawings to draw attention to certain features of the invention, it should be understood that the Applicant claims protection in respect to any patentable feature or combination of features referred to in the specification or drawings. The drawings are provided to illustrate features of the invention, but the claimed invention is expressly not limited to the illustrated embodiments.

We claim:

1. A method of recharging a traction storage device in an electric vehicle, comprising:
(1) generating energy by positioning an inertial mass on a low-friction rotational apparatus that is generally parallel to a ground plane upon which said electric vehicle is traveling up to and including highway speeds and moved against by the lateral motions of that vehicle as a causative force to generate a series of repetitive pulses of variable frequency electricity;
(2) rectifying and transferring said energy into said traction storage device, such as a Lithium chemistry battery, to recharge that device.

2. An alternator, generator, or other power generation device mechanically driven by the action of an electric vehicle traveling at velocities up to highway speeds against an inertial mass suspended by a low-friction apparatus on said vehicle.

3. A bi-directional electrical switching circuit integral with an alternator, generator, or other power generation device of claim 2 that will supply the correct polarity of electricity at suitable voltages to supply a net gain of energy to a traction storage device on an electric vehicle.
